(19) United States
(12) Patent Application Publication
(10) Pub. No.: US 2014/0274384 A1
(43) Pub. Date: Sep. 18, 2014

(54) DELIVERING AND CONSUMING INTERACTIVE VIDEO GAMING CONTENT

(71) Applicant: ELECTRONIC ARTS INC., Redwood City, CA (US)

(72) Inventors: Colin Boswell, Millbrae, CA (US); Scott Cronce, Pacifica, CA (US); Owen Grace, Asheville, NC (US); Richard Hilleman, San Mateo, CA (US); Lily Li, Millbrae, CA (US); Qian Liu, Foster City, CA (US); Joe McCabe, Napa, CA (US); Ben Medler, San Francisco, CA (US); Joseph Sutton, Hayward, CA (US)

(73) Assignee: ELECTRONIC ARTS INC., Redwood City, CA (US)

(21) Appl. No.: 14/213,669

(22) Filed: Mar. 14, 2014

Related U.S. Application Data
(60) Provisional application No. 61/852,487, filed on Mar. 15, 2013.

(51) Int. Cl. A63F 13/30

(52) U.S. Cl. CPC A63F 13/12
USPC 463/31

(57) ABSTRACT

Delivering and consuming interactive video gaming content is described. An operation for such may include transmitting, over a network to a video content decoding appliance, one or more video frames of a video content item associated with a session related to an interactive video game; receiving, over the network, a game control input from a client computing device associated with the session; and modifying, in view of the game control input, a state of the session.

### CROSS-REFERENCE TO RELATED APPLICATIONS

This application claims the benefit of U.S. Provisional Application No. 61/852,487, filed Mar. 15, 2013, the entirety of which is incorporated herein by reference.

### BACKGROUND

An interactive video game may be provided by a computer system (also referred to as “gaming platform”) that is programmed to generate video content that is defined by a game scenario and user inputs received via a game controller. The latter refers to a specialized input device comprising various game control elements, such as buttons, joysticks, switches, levers, wheels, etc.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 schematically illustrates an overview of an example distributed computer system operating in accordance with one or more aspects of the present disclosure;

FIG. 2 schematically illustrates a high-level network diagram of an example distributed computer system operating in accordance with one or more aspects of the present disclosure;

FIG. 3 schematically illustrates an example flow of interactions between various components of distributed computer system 1000 of FIG. 2, in accordance with one or more aspects of the present disclosure;

FIG. 4 depicts screen shots of a client computing device and a display device connected to a video content decoding appliance, illustrating the user's logging in to the online gaming platform;

FIG. 5 depicts screen shots of a client computing device and a display device connected to a video content decoding appliance, illustrating the user's browsing the game catalog;

FIG. 6 depicts screen shots of a client computing device and a display device connected to a video content decoding appliance, illustrating the user's launching a game;

FIG. 7 depicts a flowchart describing an example interaction of two users with the online gaming platform for joining the same gaming session, in accordance with one or more aspects of the present disclosure;

FIG. 8 illustrates various game control elements presented to the user by the game control application running on a client computing device, in accordance with one or more aspects of the present disclosure;

FIG. 9 illustrates various game control elements presented to the user by the game control application running on a client computing device, in accordance with one or more aspects of the present disclosure;

FIG. 10 illustrates an example context-sensitive help screen provided by the game controller application responsive to receiving a user's input associated with a game control, in accordance with one or more aspects of the present disclosure;

FIG. 11A schematically illustrates an example of a first background of the main window of the game controller application, in accordance with one or more aspects of the present disclosure;

FIG. 11B schematically illustrates an example of a second background of the main window of the game controller application, in accordance with one or more aspects of the present disclosure;

FIG. 11C schematically illustrates an example of a third background of the main window of the game controller application, in accordance with one or more aspects of the present disclosure;

FIG. 12 illustrate an example context-sensitive help screen rendered by the game control application running on a client computing device, in accordance with one or more aspects of the present disclosure;

FIG. 13 depicts an example of using a user provided image within a game scene, in accordance with one or more aspects of the present disclosure;

FIG. 14 depicts a flowchart describing an example interaction of a user with the online gaming platform for purchasing a downloadable content item, in accordance with one or more aspects of the present disclosure;

FIG. 15 depicts a flow diagram of an example method for delivering interactive video game content by an online video gaming platform, in accordance with one or more aspects of the present disclosure.

FIG. 16 depicts a flow diagram of an example method for providing an interactive game controller application by a client computing device, in accordance with one or more aspects of the present disclosure; and

FIG. 17 depicts a block diagram of an illustrative computing device operating in accordance with one or more aspects of the present disclosure.

### DETAILED DESCRIPTION

Described herein are methods and systems for delivering and consuming interactive video gaming content.

An interactive video game may be delivered to a general purpose computing device by an online gaming platform which may be accessible over a network (e.g., the Internet). The general purpose computing device may be provided, for example, by a desktop or a portable personal computer which may, for improving the user's gaming experience, be equipped with a peripheral device functioning as a game controller. The latter may be provided by a specialized input device that may be specific for a particular game or a particular class of games (e.g., a steering wheel game controller for various automobile simulation games).

As many households are equipped with a large screen television (TV) set which is connected to the Internet via an IP-enabled set-top box (STB), employing the TV set as the main video rendering device for interactive video games may further improve the user's gaming experience. However, a conventional set-top box may lack the user interface functionality that may be needed for adequately enabling the user's interaction with the online gaming platform. Furthermore, a conventional set-top box may not be capable of interfacing to various game controller devices and transmitting the game controller inputs to the online gaming platform.

The present disclosure enables, in an illustrative example, using an STB-equipped TV set as a video rendering device for interactive video games delivered by an online gaming platform, by providing systems and methods for delivering and consuming interactive video gaming content, as described in more details herein below.

In accordance with one or more aspects of the present disclosure, a user may employ a general purpose computing device computing device (such as a mobile computing device or a desktop personal computer) to connect to an online gaming platform using an Internet browser or a standalone application. The user may select, from a game catalog provided by the online gaming platform, an interactive video game to be played. Responsive to receiving the user's selection, the online gaming platform may create a new instance of the game or retrieve a previously saved instance of the game associated with the user account, and push the video content of the game to a video content decoding appliance (such as an IP-enabled STB) associated with the user account. The client computing device (e.g., a tablet computer) may download, from the online gaming platform, a browser-based game controller application (or launch a previously downloaded standalone game controller application). The game controller application may render on the screen of the client computing device a plurality of graphical user interface (GUI) elements representing game controls (buttons, joysticks, switches, levers, wheels, etc.). The client computing device may, via various user interfaces (e.g., a touchscreen-based GUI), receive game control inputs and forward the game control inputs to the online gaming platform executing the instance of the interactive video game. The online gaming platform may update the state of the gaming session based on the received user inputs and push to the STB the video content reflecting the updated state of the gaming session.

Employing a downloadable game controller application provides numerous advantages over conventional game controllers, including improving the user's experience by providing context-sensitive user interface features, providing context-sensitive game control elements, and allowing to import client-side data into the game, and as described in more details herein below. The game commands received via the game controller application may be sent to the online gaming platform which may interpret them as both traditional control input choices and/or richer contextual informed decisions. Employing a downloadable game controller application also facilitates the version control with respect to the game controller, as a game controller application version corresponding to the game version being executed by the game server may be downloaded by the client device upon initiating a gaming session.

In certain implementations, two or more users may employ client computing devices (e.g., tablet computers) to connect to the same gaming session and thus play the same instance of a multi-player interactive video game. In an illustrative example, two or more users may be located in the same room and hence may receive the visual and audio feedback from the online gaming platform via a shared STB-connected display device. In another illustrative example, two or more users may be located in geographically distributed locations, and each user may receive the visual and audio feedback from the online gaming platform via a dedicated STB-connected display device. In a further illustrative example, a first subset of the users playing the same instance of an interactive video game may be located in the same room and use a shared STB-connected display device, while a second subset of the users may be located in in geographically distributed locations and hence use a plurality of geographically distributed STB-connected display devices.

In certain implementations, the user may employ the client computing device to perform game-related transactions (such as downloadable content purchase transactions), browse online game catalog, and/or perform user account maintenance tasks.

Various aspects of the methods and systems are described herein by way of examples, rather than by way of limitation. The methods described herein may be implemented by hardware (e.g., general purpose and/or specialized processing devices, and/or other devices and associated circuitry), software (e.g., instructions executable by a processing device), or a combination thereof.

FIG. 1 schematically illustrates an overview of an example distributed computer system operating in accordance with one or more aspects of the present disclosure. A user may employ a mobile computing device 132 (e.g., provided by a tablet computer equipped with a wireless communication interface and a GUI) to connect to a web server of an online gaming service provider. Responsive to connecting to the web server, mobile computing device 132 may download and display, within an Internet browser, a catalog of interactive video games available for the user. In certain implementations, the user may be required to login to the service provider website, as described in more details herein below. Responsive to receiving the user's selection of a game, mobile computing device 132 may launch a game controller application (e.g., provided by a browser-based application or a platform-specific standalone application). Video content decoding appliance 134 may receive, via a network interface, the video content stream associated with the interactive video game selected by the user, and may cause the video content stream to be rendered by a display device 136 communicatively coupled to the video content decoding appliance, as described in more details herein below.

FIG. 2 schematically illustrates a high-level network diagram of an example distributed computer system 1000 operating in accordance with one or more aspects of the present disclosure. Computing devices, appliances, and network segments are shown in FIG. 2 for illustrative purposes only and do not in any way limit the scope of the present disclosure. Various other computing devices, components, appliances, and/or methods of their interconnection may be compatible with the methods and systems described herein for delivering and consuming interactive video gaming content. Various functional or architectural network components (e.g., firewalls, load balancers, network switches, user directories, content repositories, etc.) may be omitted from FIG. 2 for clarity.

In an illustrative example, distributed computer system 1000 may comprise a service provider network 110 interconnected, over on one or more networks 120, to one or more client networks 130. Networks 120 may comprise one or more local area networks and/or one or more wide area networks (e.g., the Internet). Networks 110 and 130 are in the illustrative example of FIG. 2 shown as local area networks, however, in other examples each of networks 110 and 130 may be provided by a combination of two or more various networks.

Computing devices connected to service provider network 110 may comprise one or more computing devices executing one or more software programs to deliver the functionality of online gaming platform 111. The latter may comprise a web/application server 112, a session server 114 and a game server 116. While in the illustrative example of FIG. 2, each functional component of online gaming platform 111 is shown as running on a dedicated computing device (e.g., a server computer), in other implementations, two or more functional components of online gaming platform 111 may be collocated on a single computing device, and/or a single functional component may be executed by two or more computing devices.

Computing devices connected to a client network 130 may comprise one or more client computing devices 132 and one or more video content decoding appliances 134. Client computing device 132 may, in various implementations, be provided by a mobile computing device equipped with a wireless network interface (e.g., a tablet computer or a smartphone) or a desktop personal computer. In an illustrative example, client computing device 132 may comprise one or more user interface devices, including, e.g., a touch screen, a video or still image camera, and/or a microphone.

Video content decoding appliance 134 may be provided by an IP-enabled set-top box (STB) including a network interface card, an IPTV signal transducer, and one or more video signal outputs. The IPTV signal transducer may be configured to convert video content items received via the network interface card to a video signal to be outputted to one or more display devices connected to the video signal outputs. In certain implementations, video content decoding appliance 134 may further comprise one or more TV signal inputs (e.g., a satellite and/or a cable signal input). Video content decoding appliance 134 may have one or more gaming platform client software modules installed to enable video content decoding appliance 134 operate in accordance with one or more aspects of the present disclosure.

In accordance with one or more aspects of the present disclosure, the user of client computing device 132 may employ the client computing device to connect to connect to web/application server 112 using an Internet browser or a standalone application. The user may browse a game catalog, launch and play games using a game controller application running on client computing device, and perform various game-related transactions, as described in more details herein below. In certain implementations, the game controller application may include two or more game controllers for two or more interactive video games.

In certain implementations, client computing device 132 and video content decoding appliance 134 may be provided by a single computing device. In an illustrative example, video content decoding appliance 134 may be equipped with one or more user input devices (e.g., an infrared remote control device) and may further download and run a video game controller application, thus performing the functions of both client computing device 132 and video content decoding appliance 134.

FIG. 3 schematically illustrates an example flow of interactions between various components of distributed computer system 1000 of FIG. 2, in accordance with one or more aspects of the present disclosure. FIGS. 4-6 schematically illustrate corresponding examples of screenshots of the user's client computing device executing the interactive video game controller application and of the display device connected to the user's video content decoding appliance.

A user of client computing device 132 may employ the client computing device to connect to web/application server 112 using an Internet browser or a standalone application. Responsive to receiving the user's connection request, web/application server 112 may authenticate the user of client computing device 132 by employing one or more authentication factors, such as the user identifier and the user password, as schematically illustrated by example screenshots of FIG. 4. In an illustrative example, web/application server 112 may transmit, to an external authentication service or a user directory service (not shown in FIG. 2), a user authentication request comprising the authentication factors supplied by the user.

Upon successful user authentication, client computing device 132 may download, from web/application server 112, and display a game catalog 210 comprising one or more catalog entries, as schematically illustrated by example screenshots of FIG. 5. Each catalog entry may comprise an identifier of an interactive video game, a game title, and additional information associated with the game. In certain implementations, a catalog entry may comprise a video content item demonstrating the interactive video game. Responsive to receiving, via a GUI, a user's selection of the interactive video game to be played, client computing device 132 may transmit, to web/application server 112, a message 220 comprising an identifier of the interactive video game selected by the user.

Responsive to receiving message 220 from client computing device 132, web/application server 112 may create a new user session and assign a unique session identifier to the newly created session. Web/application server 112 may further transmit, to session server 114, a message 230 comprising the session identifier, the user identifier, and the game identifier.

Web/application server 112 may further transmit, to client computing device 132, a message 240 comprising the session identifier and an identifier of a game controller application to be launched by mobile computing device. In certain implementations, the identifier of the game controller application may comprise a Universal Resource Identifier (URI) of one or more files comprising the code (e.g., written in a markup language) of a browser-based game controller application. In an illustrative example, the code may be written in HyperText Markup Language version 5 (HTML5). Alternatively, other markup languages may be used to implement the code, for example, other versions of HTML, various XML languages, etc. Alternatively, the identifier of the game controller application may comprise a URI of one or more binary files comprising the executable code of a standalone (platform-specific) game controller application. Alternatively, the identifier of the game controller application may comprise a name of the file residing in the file system of client computing device 132 and comprising the binary image of a standalone (platform-specific) game controller application.

Responsive to receiving, from web/application server 112, message 240 comprising the session identifier and the game controller application identifier, client computing device 132 may download and launch the game controller application. Client computing device 132 may further transmit, to session server 114, a message 250 comprising the session identifier. Client computing device 132 may further transmit, to video content decoding appliance 134, a message 260 comprising the session identifier and the game launching information (e.g., connection parameters for connecting to game server 116). Responsive to receiving message 240, the video content decoding appliance may connect to game server 116 using the connection parameters.

Responsive to receiving messages 230 and 250 from web application server 112 and client computing device 132, respectively, session server 114 may create a new session associated with the interactive video game. Alternatively, session server 114 may retrieve, from a storage memory, a previously saved session associated with the user account and the interactive video game. Session server 114 may then transmit, to game server 116, a message 270 comprising the session identifier, the game identifier, and the values of various game instance parameters.

Responsive to receiving message 270, game server 116 may initialize the game instance, and generate one or more video content items. Each video content item may comprise a sequence of computer-generated images based on the game scenario, game instance parameters, and the user inputs received via the game controller application being executed by client computing device 132. The computer-generated imagery (CGI) may comprise a plurality of simulated objects represented by a finite number of 2D shapes and/or 3D shapes. The geometric shapes comprised by the simulated object may have a color, color pattern, and/or texture over their surface. The simulated object may be generated from mathematical models describing the surfaces of the objects and/or from stored images of the objects.

Game server 116 may transmit the generated video content items to video content decoding appliance 134. Each video content item may comprise one or more encoded image frames. In certain implementations, the video content items transmitted by game server 116 to video content decoding appliance 134 may be encrypted for preventing the content consumption by an unauthorized third party. Responsive to receiving the video content items, video content decoding appliance 134 may decode the video frames and display the sequence of video frames 290 on display device 136 connected to the video output of video content decoding appliance 134, as schematically illustrated by example screenshots of FIG. 6.

The game controller application may render on the screen of client computing device 132 a plurality of GUI elements representing game controls (buttons, joysticks, switches, levers, wheels, etc.). Client computing device 132 may, via various user interfaces (e.g., a touchscreen-based GUI), receive game control inputs and transmit one or more messages 285 based on the game control inputs to the online gaming platform 111 (e.g., via web/application server 112, session server 114, and/or game server 116).

Game server 116 may update the state of the session based on the received user inputs and generate a sequence of computer-generated images based on the game scenario, game instance parameters, and the user inputs received via the game controller application being executed by client computing device 132. “State of a session” herein refers to a plurality of memory variables associated with a particular game instance and/or the related user session. Game server 116 may then transmit a message 290 comprising one or more generated video content items to video content decoding appliance 134.

In certain implementations, distributed computer system 1000 may comprise two or more client computing devices 132A-132B. In an illustrative example, two or more users may employ client computing devices 132A-132B (e.g., tablet computers) to connect to the same gaming session provided by online gaming platform 111 and thus play the same instance of an interactive video game. The users may be located in the same room and hence may receive the visual and audio feedback from online gaming platform 111 via a shared display device (e.g., a TV set or display monitor) 136A connected to video content decoding appliance 134A.

In certain implementations, distributed computer system 1000 may further comprise two or more video content decoding appliances 134A-134B, each video content decoding appliance connected to a respective display device (e.g., a TV set) 136A-136B. In an illustrative example, two or more users located in two or more geographically distributed locations may employ client computing devices 132A-132B (e.g., tablet computers) to connect to the same gaming session provided by online gaming platform 111 and thus play the same instance of an interactive video game. Each user may receive the visual and audio feedback from online gaming platform 111 via a dedicated display device (e.g., a TV set, display monitor, etc.) 136A-136B connected to video content decoding appliance 134A-134B. In another illustrative example, a first subset of the users playing the same instance of an interactive video game may be located in the same room and use a shared display device (e.g., a TV set) connected to a video content decoding appliance, while a second subset of the users may be located in in geographically distributed locations and hence use a plurality of geographically distributed shared display devices (e.g., a TV set) connected to video content decoding appliances.

FIG. 7 depicts a flowchart describing an example interaction of two users with the online gaming platform for joining the same gaming session. At block 710, a first user employs a first client computing device to initiate a new gaming session with the online gaming platform, as described in more details herein above.

At block 720, the session server, responsive to receiving the first user's request, creates a new gaming session.

At block 730, the session server transmits, to the web/application server, a message comprising the session identifier and session parameters of the newly created session.

At block 740, a second user employs a second client computing device to connect to the web/application server and requests to join the gaming session that was initiated by the first user. In an illustrative example, the URL for connecting to the gaming session may be displayed on the display device connected to the second user's video content decoding appliance. Alternatively, a QR code encoding the URL for connecting to the gaming session may be displayed on the display device connected to the second user's video content decoding appliance, so that the second user may point the camera of the client computing device to the QR code in order to join the gaming session. In various other illustrative examples, the connection of the client computing device to the web/application server may be facilitated in numerous other ways.

At block 750, the session server joins the second user's game controller application to the gaming session that was previously established by the first user. Thus, the first and the second user become connected to the same gaming session provided by the online gaming platform and thus may play the same instance of a multi-player interactive video game.

In certain implementations, the game controller application may include various game control inputs that enable the current gaming session to be paused, resumed, or terminated, requesting a context-sensitive help from the online gaming platform, or zooming in/zooming out the current view of the game controller application or the display device connected to the video content decoding appliance. In an illustrative example of FIG. 8, the game controller application has game control inputs that include a pause button 810 that brings up a pause menu and a help button 820 that opens a help overlay 830. Responsive to detecting the user's tapping one of the pause button or the help button, the game controller application may notify the online gaming platform of the user's action. Responsive to receiving the notification, the online gaming platform may pause displaying of the game video content on the display device connected to the user's video content decoding appliance.

In another illustrative example, the game may also be paused by the online gaming platform responsive to determining that the period of the user's inactivity with respect to the game controller application exceeds a pre-defined threshold period of time. In a further illustrative example, the game may also be paused by the online gaming platform responsive to receiving a message from the game controller application notifying the online gaming platform that the main window of the game controller application has lost the focus (e.g., due to user's switching to another application on the client computing device).

In certain implementations, the game controller application may include various context-sensitive features dependent upon the state of the gaming session. In an illustrative example, the game controller application may, based on the state of the gaming session, modify the interaction choices available to the user, by adding or removing the GUI elements representing game controls (buttons, joysticks, switches, levers, wheels, etc.) available to the user. The game controller application may add one or more game control elements that may be activated by the user in the current game context (e.g., a game control element triggering an action which is available to the user based on the user's entitlements). Conversely, the game controller application may remove one or more game control elements that may not be activated by the user in the current game context (e.g., a game control element triggering an action which is unavailable to the user based on the user's entitlements). In certain implementations, various game control GUI elements may be labeled by context-sensitive labels. In an illustrative example, a label associated with a game control GUI element may change reflecting the changing game control functionality based on the game context. Providing various context-sensitive features in the game controller application allows the online gaming platform to interpret the user actions as both traditional gaming button choices and/or richer contextually informed decisions.

In an illustrative example, the game controller application for a golf-simulating game includes a club selecting wheel 910 game control input showing the clubs available to the user, as schematically illustrated by FIG. 9. The user may select a club by tapping the icon corresponding to the club.

In another illustrative example, the game controller application may, responsive to receiving a user's input associated with a game control, provide a context-sensitive help on using the game control. As schematically illustrated by FIG. 10, responsive to detecting the user's dragging back the golf ball icon 1010, the game controller application may display one or more arrows 1020 indicating that the user can swipe the control in one of the directions indicated by the arrows, or release the control in order to hit the golf ball.

In another illustrative example, the game controller application may, based on the state of the gaming session, change the visual appearance of one or more displayed GUI elements representing game controls. As schematically illustrated by FIGS. 11A-11C, the background 1110 of the main window of the game controller application may change responsive to the golf ball landing in the green, in the sand, or in the mulch.

In certain implementations, the game controller application may provide a context-sensitive help based on the state of the gaming session responsive to receiving a user's request. In an illustrative example, the game controller application may download, from online gaming platform 111, and play back on the screen of client computing device 132, one or more video content items informing the user of the GUI elements representing available game controls. As schematically illustrated by FIG. 12, a context-sensitive help screen 1210 may provide instructions on using the game controls displayed by the game controller application.

In certain implementations, the game controller application may comprise one or more video content items and/or one or more software modules (including binary modules and markup language modules) associated with a part of the interactive video game, to be played by the user on the client computing device executing the game controller application. In an illustrative example, at least some of the video content items and/or software modules may be downloaded from online gaming platform 111 as the game progresses. Other video content items and/or software modules may be a static part of the game controller application.

Responsive to completing the playback, the game controller application may modify the state of the gaming session to reflect the results of the user's interaction with the part of the game, and transmit the modified gaming session state to online gaming platform 111. In an illustrative example, responsive to detecting a player's “gun” being “jammed” in a shooting game, the game controller application may require the user to perform certain actions to clear the jamming condition using one or more game control inputs, before allowing the player to proceed.

In another illustrative example, as schematically illustrated by FIG. 13, a user may use the game controller application to acquire his or her photo image 1310 and to upload image 1310 to the gaming platform. Responsive to receiving the user's image, the gaming platform may insert user's image 1310 into a game scene 1320 to be rendered within the game controller application and/or on the display device connected to the video content decoding appliance.

In certain implementations, the game controller application may be employed to provide the client-side context to online gaming platform 111. In an illustrative example, the game controller application may acquire the geo-positioning data using a geo-positioning device (e.g., a GPS receiver) built-in or connected to client computing device 132. The game controller application may transmit, to online gaming platform 111, a message comprising the geo-positioning data. Responsive to receiving the message, online gaming platform 111 may modify the state of the gaming session based on the geo-positioning data. In an illustrative example, online gaming platform may determine a distance traveled by the user carrying a mobile computing device over a period of time, by acquiring a plurality of geo-positions of the mobile computing device. The online gaming platform may then determine a distance which the user's hero is allowed to travel in the simulated reality of the gaming session, as a function of the distance actually traveled by the user in the real world.

In certain implementations, the game controller application may acquire one or more images using an imaging device (e.g., a video or still image camera) built-in or connected to client computing device 132. The game controller application may transmit, to online gaming platform 111, a message comprising the acquired images. Responsive to receiving the message, online gaming platform 111 may modify the state of the gaming session based on the geographical location of client computing device. In illustrative example, online gaming platform 111 may insert the images acquired by client computing device 132 into one or more video content items transmitted to video content decoding appliance 134. In another illustrative example, online gaming platform 111 may insert the images acquired by client computing device 132 into one or more computer generated images transmitted to the game controller application for displaying on the screen of client computing device 132. In another illustrative example, online gaming platform 111 may use as game data one or more the images that were previously acquired by the user's client device.

In certain implementations, online gaming platform 111 may provide various methods for the user to acquire additional content for interactive video games. The additional game content may be referred to as downloadable content (DLC). A DLC item may represent various aspects of an interactive video game, including, e.g., additional screen backgrounds, additional hero outfits, additional storylines, etc. In certain implementations, the game controller application may comprise one or more user interface controls for purchasing a DLC item from within the gaming session.

FIG. 14 depicts a flowchart describing an example interaction of a user with the online gaming platform for purchasing a DLC item. At block 1410, the user may request to purchase DLC from within the gaming session, by using one or more game controls within the game controller application.

At block 1420, the video content decoding appliance receives, from the online gaming platform, a video content item comprising DLC purchase information. The video content decoding appliance switches from the game screen to the DLC purchase screen.

At block 1430, the game controller application receives, from the online gaming platform, a command to display a user interface control element (e.g., a popup window) prompting the user to confirm the purchase of the selected DLC item.

Responsive to determining, at block 1440, that that user has agreed to the purchase, the purchase transaction may be completed by the online gaming platform, and the user's entitlement to the purchased DLC item may be stored in the catalog at block 1450. Otherwise, at block 1460, a message may be transmitted to notify the game server that the requested DLC item is not available.

At block 1470, a message may be transmitted to notify the game server that the requested DLC item is available.

At block 1480, the video content decoding appliance receives, from the online gaming platform, one or more video content items comprising the next part of the game. The video content decoding appliance switches from the DLC purchase screen to the game screen.

Alternatively, the user may select one or more DLC items outside of a gaming session (e.g., from the catalog view being displayed by the user's client computing device).

The above described examples of interactions of various components of distributed computer system 1000 do not in any way limit the scope of the present disclosure. Various other scenarios of interactions of the above described functional components of distributed computer system 1000 may be compatible with the methods and systems described herein.

FIG. 15 depicts a flow diagram of an example method 1500 for delivering interactive video gaming content by an online gaming platform, in accordance with one or more aspects of the present disclosure. Method 1500 and/or each of its individual functions, routines, subroutines, or operations may be performed by one or more general purpose and/or specialized processing devices. Two or more functions, routines, subroutines, or operations of method 1500 may be performed in parallel or in an order which may differ from the order described above. In certain implementations, method 1500 may be performed by a single processing thread. Alternatively, method 1500 may be performed by two or more processing threads, each thread executing one or more individual functions, routines, subroutines, or operations of the method. In an illustrative example, the processing threads implementing method 1500 may be synchronized (e.g., using semaphores, critical sections, and/or other thread synchronization mechanisms). Alternatively, the processing threads implementing method 1500 may be executed asynchronously with respect to each other. In an illustrative example, method 1500 may be performed by computing device 1700 described herein below with references to FIG. 17.

Referring to FIG. 15, at block 1510, a processing device may receive, from a client device, a message comprising an identifier of a user of an online gaming platform.

At block 1515, the processing device may authenticate the user. In an illustrative example, the processing device may transmit, to an external authentication service or a user directory service, a user authentication request comprising the authentication factors supplied by the user.

At block 1520, the processing device may transmit, to the client device, a game catalog comprising one or more catalog entries. In an illustrative example, each catalog entry may comprise an identifier of an interactive video game, a game title, and additional information associated with the game.

At block 1525, the processing device may receive, from the client device, a message comprising an identifier of the interactive video game selected by the user of the client device.

At block 1530, the processing device may create a new user session and assign a unique session identifier to the newly created session. In certain implementations, the processing device may determine whether a session associated with the user identifier and the game identifier has previously been saved on a storage device, and if so, retrieve the session state and the session identifier of the previously created session.

At block 1535, the processing device may transmit, to the client device, a message comprising the session identifier and an identifier of a game controller application to be launched by mobile computing device. In certain implementations, the identifier of the game controller application may comprise a Universal Resource Identifier (URI) of one or more files comprising the code (e.g., HTML5 code) of a browser-based game controller application. Alternatively, the identifier of the game controller application may comprise a URI of one or more binary files comprising the executable code of a standalone (platform-specific) game controller application. Alternatively, the identifier of the game controller application may comprise a name of the file residing in the file system of the client device and comprising the binary image of a standalone (platform-specific) game controller application.

At block 1540, the processing device may receive, from a video content decoding appliance, a message comprising the session identifier.

At block 1545, the processing device may transmit, to the video content decoding appliance, one or more video content items associated with the session. In an illustrative example, each video content item may comprise a sequence of computer-generated image frames based on the game scenario, game instance parameters, and the user inputs received via the game controller application being executed by the client device. In an illustrative example, each video content item may comprise a sequence of computer-generated image frames of a DLC purchase transaction, as described in more details herein above.

At block 1550, the processing device may receive, from the client device, one or more input values (e.g., values of game control input variables or DLC purchase transaction input variables) associated with the session.

At block 1555, the processing device may update the state of the session based on the received input values.

At block 1560, the processing device may generate a sequence of computer-generated images based on the game scenario, game instance parameters, and the received input values.

At block 1565, the processing device may transmit the generated video content items to the video content decoding appliance. Upon completing the operations described with references to block 1560, the method may loop back to block 1550 for receiving the input values from the client device.

FIG. 16 depicts a flow diagram of an example method 1600 for controlling an interactive video game by a game controller application running on a general purpose computing device, in accordance with one or more aspects of the present disclosure. Method 1600 and/or each of its individual functions, routines, subroutines, or operations may be performed by one or more general purpose and/or specialized processing devices. Two or more functions, routines, subroutines, or operations of method 1600 may be performed in parallel or in an order which may differ from the order described above. In certain implementations, method 1600 may be performed by a single processing thread. Alternatively, method 1600 may be performed by two or more processing threads, each thread executing one or more individual functions, routines, subroutines, or operations of the method. In an illustrative example, the processing threads implementing method 1600 may be synchronized (e.g., using semaphores, critical sections, and/or other thread synchronization mechanisms). Alternatively, the processing threads implementing method 1600 may be executed asynchronously with respect to each other. In an illustrative example, method 1600 may be performed by computing device 1700 described herein below with references to FIG. 17.

Referring to FIG. 16, at block 1610, a processing device may receive, from an online gaming platform, a game catalog comprising one or more catalog entries. Each catalog entry may comprise an identifier of an interactive video game, a game title, and additional information associated with the game. The processing device may further render the game catalog on the screen.

At block 1620, the processing device may receive, via a GUI, a game identifier selected by the user.

At block 1630, the processing device may transmit, to the online gaming platform, a message comprising the game identifier.

At block 1640, the processing device may receive, from the interactive video gaming platform, a message comprising a session identifier and an identifier of a game controller application.

At block 1650, the processing device may transmit, to a video content decoding appliance, a message comprising the session identifier.

At block 1660, the processing device may download and launch the game controller application identifier by the game controller application identifier received from the online gaming platform.

At block 1670, the processing device may receive, via the GUI, one or more input values (e.g., values of game control input variables or DLC purchase transaction input variables) associated with the session.

At block 1680, the processing device may transmit, to the online gaming platform, a message comprising the input values. Upon completing the operations described with references to block 1680, the method may loop back to block 1670 for receiving, via the GUI, the input values.

FIG. 17 illustrates a diagrammatic representation of a computing device 1700 within which a set of instructions, for causing the computing device to perform the methods discussed herein, may be executed. Computing device 1700 may be connected to other computing devices in a LAN, an intranet, an extranet, and/or the Internet. The computing device may operate in the capacity of a server machine in client-server network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein. In certain implementations, computing device 1700 may correspond to client device 132 of FIG. 2. In certain implementations, computing device 1700 may correspond to web/application server 112, session server 114, and/or game server 116 of FIG. 2.

The example computing device 1700 may include a processing device (e.g., a general purpose processor) 1002, a main memory 1004 (e.g., synchronous dynamic random access memory (DRAM), read-only memory (ROM)), a static memory 1006 (e.g., flash memory and a data storage device 1018), which may communicate with each other via a bus 1030.

Processing device 1002 may be provided by one or more general purpose processing devices such as a microprocessor, central processing unit, or the like. In an illustrative example, processing device 1002 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 1002 may also comprise one or more special-purpose processing devices such as an application specific integrated circuit (ASIC), a field programmable gate array (FPGA), a digital signal processor (DSP), network processor, or the like. The processing device 1002 may be configured to execute method 1500 for delivering interactive video game content by an online gaming platform and/or method 1600 for providing an interactive video game controller application by a client computing device, in accordance with one or more aspects of the present disclosure.

Computing device 1700 may further include a network interface device 1008 which may communicate with a network 1020. The computing device 1700 also may include a video display unit 1010 (e.g., a liquid crystal display (LCD) or a cathode ray tube (CRT)), an alphanumeric input device 1012 (e.g., a keyboard), a cursor control device 1014 (e.g., a mouse) and an acoustic signal generation device 1016 (e.g., a speaker). In an illustrative example, video display unit 1010, alphanumeric input device 1012, and cursor control device 1014 may be combined into a single component or device (e.g., an LCD touch screen).

Data storage device 1018 may include a computer-readable storage medium 1028 on which may be stored one or more sets of instructions (e.g., instructions of method 1500 for delivering interactive video game content by an online gaming platform and/or method 1600 for providing an interactive video game controller application by a client computing device, in accordance with one or more aspects of the present disclosure) implementing any one or more of the methods or functions described herein. Instructions implementing methods 1500 and/or 1600 may also reside, completely or at least partially, within main memory 1004 and/or within processing device 1002 during execution thereof by computing device 1700, main memory 1004 and processing device 1002 also constituting computer-readable media. The instructions may further be transmitted or received over a network 1020 via network interface device 1008.

While computer-readable storage medium 1028 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “updating”, “identifying”, “determining”, “sending”, “assigning”, or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc. as used herein are meant as labels to distinguish among different elements and may not necessarily have an ordinal meaning according to their numerical designation.

Examples described herein also relate to an apparatus for performing the methods described herein. This apparatus may be specially constructed for the required purposes, or it may comprise a client computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

What is claimed is:

1. A non-transitory computer-readable storage medium comprising executable instructions that, when executed by a processing device, cause the processing device to perform operations, comprising:
transmitting, over a network to a video content decoding appliance, one or more video frames of a video content item associated with a session related to an interactive video game;
receiving, over the network, an input value from a client computing device associated with the session; and
modifying, in view of the input value, a state of the session.

2. The non-transitory computer-readable storage medium of claim 1, further comprising executable instructions causing the processing device to perform operations, comprising:
transmitting, by a processing device, to the video content decoding appliance, a message reflecting the state of the session.

3. The non-transitory computer-readable storage medium of claim 1, wherein the client computing device is provided by a mobile computing device running a video game controller application.

4. The non-transitory computer-readable storage medium of claim 1, wherein the client computing device and the video content decoding appliance are provided by one computing device.

5. The non-transitory computer-readable storage medium of claim 1, wherein the session is associated with one of an instance of an interactive video game or a content purchase transaction related to an interactive video game.

6. The non-transitory computer-readable storage medium of claim 1, further comprising executable instructions causing the processing device to perform operations, comprising:
receiving, over the network, a first message from the client computing device, the first message comprising a game identifier identifying the interactive video game; and
transmitting, over the network, a second message to the client computing device, the second message comprising a session identifier identifying the session associated with the interactive video game.

7. The non-transitory computer-readable storage medium of claim 1, further comprising executable instructions causing the processing device to perform operations, comprising:
transmitting, to the client computing device, an identifier of a game controller application.

8. The non-transitory computer-readable storage medium of claim 7, wherein the game controller application is provided by one of a browser-based application or a standalone application.

9. The non-transitory computer-readable storage medium of claim 1, further comprising executable instructions causing the processing device to perform operations, comprising:
receiving, over the network, a second input value from a second client computing device; and
modifying, in view of the second input value, the state of the session.

10. The non-transitory computer-readable storage medium of claim 9, further comprising executable instructions causing the processing device to perform operations, comprising:
transmitting, to a second video content decoding appliance, a second message reflecting the state of the session.

11. The non-transitory computer-readable storage medium of claim 1, further comprising executable instructions causing the processing device to perform operations, comprising:
receiving a user identifier; and
retrieving from the storage device a state of a session associated with the user identifier.

12. The non-transitory computer-readable storage medium of claim 1, further comprising executable instructions causing the processing device to perform operations, comprising:
transmitting, to the client computing device, a video content item comprising help information for the interactive video game.

13. The non-transitory computer-readable storage medium of claim 1, further comprising executable instructions causing the processing device to perform operations, comprising:
transmitting, to the client computing device, at least one of a video content item or a software module associated with a part of the interactive video game; and
receiving, from the client computing device, the state of the session modified by the client computing device.

14. A system comprising:
a mobile computing device equipped with a wireless communication interface and a graphical user interface (GUI), the mobile computing device to:
receive, via the wireless communication interface, a catalog comprising one or more game identifiers,
receive, via the GUI, a game identifier selected by a user,
launch a game controller application for an interactive video game identified by the game identifier; and
a video content decoding appliance equipped with a network interface, the video content decoding appliance to:
receive, via the network interface, a video content item associated with the interactive video game, and
cause the video content item to be rendered by a display communicatively coupled to the video content decoding appliance.

15. A non-transitory computer-readable storage medium comprising executable instructions that, when executed by a processing device, cause the processing device to perform operations, comprising:
receiving, via a network interface, a catalog comprising one or more game identifiers identifying one or more interactive video games;
receiving, via a GUI, a game identifier selected by a user;
transmitting, to an interactive video gaming server, a first message comprising the game identifier;
receiving, from the interactive video gaming server, a second message comprising a session identifier and a game controller application identifier; and
launching a game controller application identified by the game controller application identifier.

16. The non-transitory computer-readable storage medium of claim 15, wherein the game controller application is provided by one of a browser-based application or a standalone application.

17. The non-transitory computer-readable storage medium of claim 15, further comprising executable instructions causing the processing device to perform operations, comprising:
transmitting, to a video content decoding appliance, a message comprising the session identifier.

18. The non-transitory computer-readable storage medium of claim 15, further comprising executable instructions causing the processing device to perform operations, comprising:
receiving a game control input via the game controller application; and
transmitting, to the interactive video gaming server, a message comprising the game control input.

19. The non-transitory computer-readable storage medium of claim 15, further comprising executable instructions causing the processing device to perform operations, comprising:
acquiring an image using an imaging device; and
transmitting the image to the interactive video gaming server.

20. The non-transitory computer-readable storage medium of claim 15, further comprising executable instructions causing the processing device to perform operations, comprising:
acquiring positioning data using a geo-positioning device; and
transmitting the positioning data to the interactive video gaming server.
